(19) United States
(12) Patent Application Publication
(10) Pub. No.: US 2014/0380089 A1
(43) Pub. Date: Dec. 25, 2014

(54) METHOD AND APPARATUS FOR RECOVERING FAILED DISK IN VIRTUAL MACHINE

(71) Applicant: ELECTRONICS AND TELECOMMUNICATIONS RESEARCH INSTITUTE, Daejeon (KR)

(72) Inventors: Hak-Jae KIM, Daejeon (KR); Hag-Young KIM, Daejeon (KR); Seong-Woon KIM, Chungcheongnam-do (KR); Dae-Won KIM, Daejeon (KR); Sun-Wook KIM, Gyeonggi-do (KR); Soo-Cheol OH, Daejeon (KR); Myeong-Hoon OH, Daejeon (KR); Jong-Bae MOON, Daejeon (KR); Jung-Hyun CHO, Daejeon (KR)

(21) Appl. No.: 14/310,125

(22) Filed: Jun. 20, 2014

(30) Foreign Application Priority Data
Jun. 21, 2013 (KR) 10-2013-0071828

(51) Int. Cl. G06F 11/20

(52) U.S. Cl. CPC G06F 11/2094
USPC 714/6.3

(57) ABSTRACT

A method and apparatus for recovering the failed disk of a virtual machine in a virtualization system are disclosed. The apparatus includes a system performance analysis unit, a failed disk recovery unit, and a disk exchange unit. The system performance analysis unit calculates recovery resources, that is, network and disk I/O bandwidths, to be assigned to the recovery of a failed disk by analyzing the performance of the virtualization system. The failed disk recovery unit performs the discovery of the failed disk by recovering a copy disk, that is, a copy of the failed disk, using a mandatory disk stored in the virtualization system while ensuring the performance of virtual machines based on the recovery resources. The disk exchange unit deletes the failed disk and assigns the recovered copy disk to a virtual machine corresponding to the failed disk.

### CROSS REFERENCE TO RELATED APPLICATION

This application claims the benefit of Korean Patent Application No. 10-2013-0071828, filed on Jun. 21, 2013, which is hereby incorporated by reference in its entirety into this application.

### BACKGROUND OF THE INVENTION

1. Technical Field

The present invention relates generally to a method and apparatus for recovering the failed disk of a virtual machine and, more specifically, to a method and apparatus that are capable of maintaining the continuity of virtualization service, thereby recovering a failed disk while ensuring the performance of virtual machines.

2. Description of the Related Art

The term “virtualization” refers to a technology that enables a plurality of operating systems to run on a single physical server. Each of these operating systems is called a virtual machine. Virtualization has advantages including the separation of the execution environments of virtual machines, an increase in the utilization of a server, the convenient management of the resources of virtual machines, and stability having no connection with the error of virtual machines.

For these advantages, virtualization is adopted in many company environments. In particular, Internet Data Centers (IDCs) or various types of portal companies in which clusters have been constructed using cheap computers have been highly interested in virtualization. Such companies attempt to use many computers having low performance as virtual machines that run on a high performance server. This task is called server consolidation. In order to construct a virtual infrastructure in which tasks performed by existing non-virtual servers are replaced with virtual servers installed on a small number of physical servers by generating virtual machines and providing service, there is a need for a physical node that will generate virtual machines and the disks of the virtual machines that will be generated on the physical node.

Conventional technologies for overcoming the failure of a virtual machine include Microsoft Exchange Server by Microsoft, XenApp by Citrix, vSphere by VMware, and onQ by Quorum. To improve recovery speed in such a way as to store copies of disk images of virtual machines in a central or distributed storage server connected over a network and recover a original using the backup copy when the failure of a virtual machine occurs, an expensive backup server and expensive network equipment are required.

U.S. Pat. No. 7,933,987 entitled “Application of Virtual Servers to High Availability and Disaster Recovery Solutions” discloses server virtualization technology. This technology is problematic in that it is difficult to overcome a real-time failure situation (e.g., within several ms) on a high-capacity virtual disk (e.g., having a capacity of several tens of gigabytes or more) and the recovery of the disk of a specific virtual machine may affect the operating speed of other virtual machines that run on the same virtualization server.

### SUMMARY OF THE INVENTION

Accordingly, the present invention has been made keeping in mind the above problems occurring in the conventional art, and an object of the present invention is to provide a method and apparatus for recovering the failed disk of a virtual machine, which are capable of ensuring the continuity of virtualization service in a server virtualization environment.

Another object of the present invention is to provide a method and apparatus for recovering the failed disk of a virtual machine, which are capable of ensuring the performance of virtual machines.

Yet another object of the present invention is to provide a method and apparatus for scheduling resources that are used to recover the failed disk of a virtual machine.

Further yet another object of the present invention is to provide a method and apparatus for recovering the failed disk of a virtual machine based on a remote storage device.

In accordance with an aspect of the present invention, there is provided a method of recovering the failed disk of a virtual machine in a virtualization system, the method including calculating the total resources of the virtualization system, that is, network and disk I/O resources; calculating operating resources used to drive the virtualization system; calculating use resources corresponding to the amount of the network and disk I/O resources used; calculating recovery resources, that is, network and disk I/O bandwidths capable of being assigned to failure recovery without disturbing performance of other virtual machines based on the total resources, the operating resources and the use resources; and performing recovery of a failed disk by recovering a copy disk, that is, a copy of the failed disk, in a stream manner using a mandatory disk stored in the virtualization system based on the recovery resources.

Performing the recovery of the failed disk may include deleting the failed disk and assigning the recovered copy disk to a virtual machine corresponding to the failed disk.

Performing the recovery of the failed disk may include recovering the failed disk by copying a copy disk, that is, a copy of a local mandatory disk stored in a local storage device, in a local stream manner using the local mandatory disk.

Performing the recovery of the failed disk may include recovering the failed disk by copying a copy disk, that is, a copy of a remote mandatory disk stored in a remote storage device, in a remote stream manner using the remote mandatory disk.

The recovery resources may be the remaining resources of the total resources other than the operating resources and the use resources.

Performing the recovery of the failed disk may be stopped if the recovery resources have not been assigned.

Performing the recovery of the failed disk may include providing all recovery tasks with assignment resources to which the recovery resources have been equally assigned if the recovery resources have been assigned; dividing the mandatory disk into a plurality of blocks; and performing recovery on each block section formed of each of the blocks based on the assignment resources.

The assignment resources may include idle resources in which the performance of the recovery is stopped.

The idle resources may be assigned based on network or disk I/O resource performed in a block section before the former block section.

Performing the recovery of the failed disk may include performing the recovery of the failed disk while periodically calculating the use resources and the recovery resources.

In accordance with another aspect of the present invention, there is provided an apparatus for recovering the failed disk of a virtual machine in a virtualization system, the apparatus including a system performance analysis unit configured to calculate recovery resources, that is, network and disk I/O bandwidths, to be assigned to the recovery of a failed disk by analyzing the performance of the virtualization system; a failed disk recovery unit configured to perform the discovery of the failed disk by recovering a copy disk, that is, a copy of the failed disk, using a mandatory disk stored in the virtualization system while ensuring the performance of virtual machines based on the recovery resources; and a disk exchange unit configured to delete the failed disk and assign the recovered copy disk to a virtual machine corresponding to the failed disk.

The system performance analysis unit may include a total resource calculation unit configured to calculate total resources, that is, total network and disk I/O resources of the virtualization system; an operating resource calculation unit configured to calculate operating resources used to drive the virtualization system; a use resource calculation unit configured to calculate use resources, that is, the amount of the network and disk I/O resources used; and a recovery resource calculation unit configured to calculate recovery resources, that is, network and disk I/O bandwidths capable of being assigned to failure discovery without disturbing the performance of other virtual machines based on the total resources, the operating resources and the use resources.

The failed disk recovery unit may include a local stream recovery unit configured to recover a copy disk, that is, a copy of a local mandatory disk stored in a local storage device, by copying the copy disk in a local stream manner using the local mandatory disk; and a remote stream recovery unit for recovering a copy disk, that is, a copy of a remote mandatory disk stored in a remote storage device, by copying the copy disk in a remote stream manner using the remote mandatory disk.

The recovery resources may be the remaining resources of the total resources other than the operating resources and the use resources.

The failed disk recovery unit may be stopped if the recovery resources have not been assigned.

The failed disk recovery unit may be performed again if the recovery resources have been assigned.

The local stream recovery unit and the remote stream recovery unit may include an assignment unit configured to provide all recovery tasks with assignment resources to which the recovery resources have been equally assigned; a division unit configured to divide the mandatory disk into a plurality of blocks; and a performance unit configured to perform recovery on each block section formed of each of the blocks based on the assignment resources.

The assignment resources may include idle resources in which the performance of the recovery is stopped.

The idle resources may be assigned based on network or disk I/O resource performed in a block section before the former block section.

The system performance analysis unit may periodically calculate the recovery resources.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a disk assignment and recovery system for virtual machines in a server virtualization environment;

FIG. 2 is a diagram illustrating an operation of recovering the failed disk of a virtual machine according to an embodiment of the present invention;

FIG. 3 is a diagram illustrating the assignment of system resources capable of performing recovery while ensuring the performance of virtual machines;

FIG. 4 is a flowchart illustrating a method of recovering the failed disk of a virtual machine according to an embodiment of the present invention;

FIGS. 5 and 6 are diagrams illustrating the execution of the method of recovering the failed disk of a virtual machine and a method of controlling resource use bands;

FIG. 7 is a block diagram of an apparatus for recovering the failed disk of a virtual machine according to an embodiment of the present invention;

FIG. 8 is a diagram illustrating the configuration of the system performance analysis unit of the apparatus for recovering the failed disk of a virtual machine according to an embodiment of the present invention;

FIG. 9 is a diagram illustrating the configuration of the failed disk recovery unit of the apparatus for recovering the failed disk of a virtual machine according to an embodiment of the present invention; and

FIGS. 10 and 11 are diagrams illustrating the configuration of the local and remote stream recovery units of the apparatus for recovering the failed disk of a virtual machine according to an embodiment of the present invention.

### DESCRIPTION OF THE PREFERRED EMBODIMENTS

Embodiments of the present invention are described in detail below with reference to the accompanying drawings. In the following description of the present invention, repetitive descriptions and detailed descriptions of known functions and configurations which are deemed to make the gist of the present invention obscure are omitted.

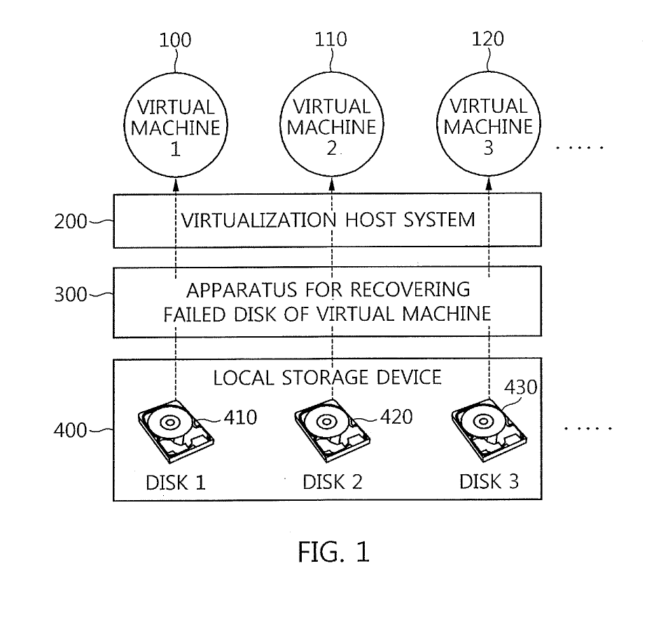

The typical configuration of a disk assignment and recovery system for virtual machines in a server virtualization environment is described below. FIG. 1 is a diagram illustrating the configuration of the disk assignment and recovery system for virtual machines in a server virtualization environment.

Referring to FIG. 1, in a server virtualization environment, a virtualization host system 200 assigns virtual disks 1, 2 and 3 410, 420 and 430 stored in a local storage device 400 to virtual machines 1, 2 and 3 100, 110 and 120. More specifically, the virtualization host system 200 assigns the disk 1 410 to the virtual machine 1 100, the disk 2 420 to the virtual machine 2 110, and the disk 3 410 to the virtual machine 3 120. Each of the virtual disks 1, 2 and 3 410, 420, and 430 may be a physical disk device, or a disk image file stored in a physical disk device.

The present invention proposes an apparatus 300 and method for recovering the failed disk of a virtual machine when any one of the disks 1, 2 and 3 410, 420 and 430 assigned to the virtual machines 1, 2 and 3 100, 110 and 120 fails. In the following description of the present invention, it is assumed that the disk 1 410 assigned to the virtual machine 1 100 has failed. Accordingly, it is assumed that the disk 2 420 and the disk 3 430 assigned to the virtual machine 2 110 and the virtual machine 3 120 normally operate.

The apparatus 300 for recovering the failed disk of a virtual machine and the method of recovering the failed disk of a virtual machine according to an embodiment of the present invention perform scheduling in order to prevent the deterioration of the performance of the virtual machine 2 110 and the virtual machine 3 120 which have not failed when recovering the disk 1 410 assigned to the virtual machine 1 100 because the disk 1 410 has failed.

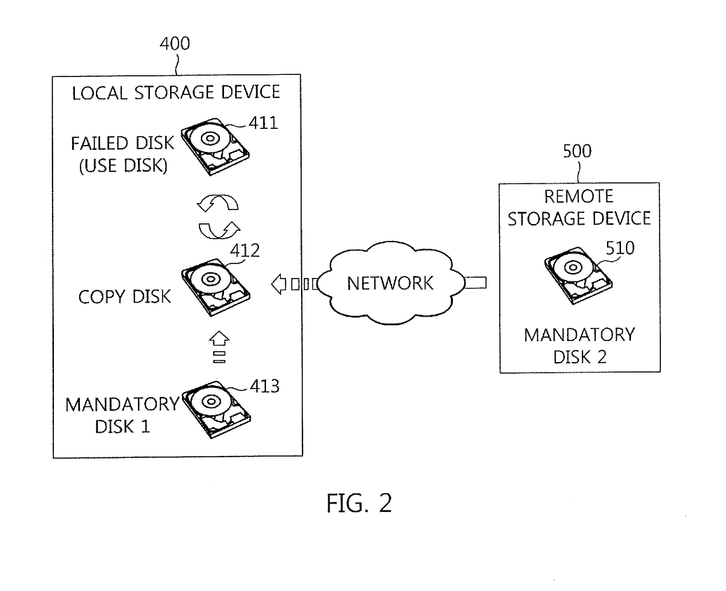

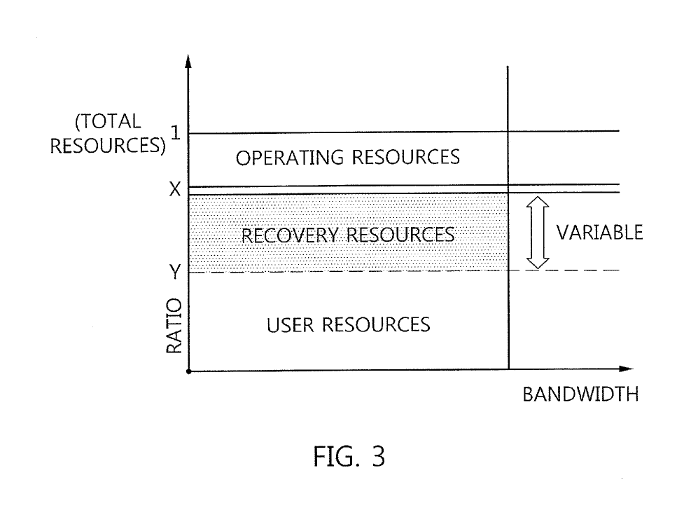

An operation of recovering the failed disk of a virtual machine according to an embodiment of the present invention is described below. FIG. 2 is a diagram illustrating an operation of recovering the failed disk of a virtual machine according to an embodiment of the present invention, and FIG. 3 is a diagram illustrating the assignment of system resources capable of performing recovery while ensuring the performance of virtual machines.

Referring to FIGS. 2 and 3, three disks including the same content are assigned to a single virtual machine. That is, the three disks include a use disk 411 now being used, a copy disk 412, that is, a copy of the use disk, and mandatory disks 413 and 510 to be used to recover the copy disk. Furthermore, the mandatory disks 1 and 2 413 and 510 may be present in the local storage device 400 or a remote storage device 500. In the following description, it is assumed that the mandatory disk 1 413 is a mandatory disk present in the local storage device 400 and the mandatory disk 2 510 is a mandatory disk present in the remote storage device 500. In the description of the operation of recovering the failed disk of a virtual machine according to this embodiment of the present invention, it is assumed that the use disk 411 now being used is a failed disk. This means that the failed disk and the use disk 411 are the same object. It is also assumed that a virtual machine to which the failed disk has been assigned is the virtual machine 1 100.

If the use disk 411 assigned to the virtual machine 1 100 has failed and thus become the failed disk 411, the copy disk 412 is recovered using the mandatory disk 1 413 stored in the local storage device 400 or the mandatory disk 2 510 stored in the remote storage device 500 in order to recover the failed disk 411. More specifically, when the copy disk 412 is recovered, a method of recovering the copy disk 412 in a stream manner is adopted. The mandatory disk 1 413 is used in a local stream manner, and the mandatory disk 2 510 is used over a network in a remote stream manner. Thereafter, the failed disk 411 is deleted and the recovered copy disk 412 is assigned to the virtual machine 1 100, thereby completing the recovery of the failed disk 411. In this case, the failed disk 411 and the copy disk 412 may be replaced with each other in real time because they are present in the same local storage device 400.

The assignment of system resources capable of performing recovery while ensuring the performance of virtual machines is described below. FIG. 3 is a diagram illustrating the assignment of system resources capable of performing recovery while ensuring the performance of virtual machines.

Referring to FIG. 3, the term “system resources” refers to input/output (I/O) and disk I/O, and total resources are assumed to be a ratio of 1. Resources required to drive a system in a virtualization server are called operating resources, and the operating resources correspond to 1−X in FIG. 3. Resources that belong to the total resources and correspond to Y other than the resources corresponding to the 1−X are used to drive a virtual machine, and are called use resources. In this case, the remaining resources of the total resources other than the operating resources and the use resources are recovery resources that are used to recover the failed disk of a virtual machine. That is, the recovery resources correspond to X−Y in FIG. 3. The recovery resources correspond to a parameter that may vary in real time depending on a change in the use resources. More specifically, the recovery resources are used to recover the failed disk of a virtual machine. If recovery resources have not been ensured (i.e., X−Y=0), an operation of recovering the failed disk of a virtual machine is stopped. Accordingly, the operations of normal virtual machines are not interrupted by the recovery of the failed disk, and the continuous operation of the entire virtual system may be guaranteed.

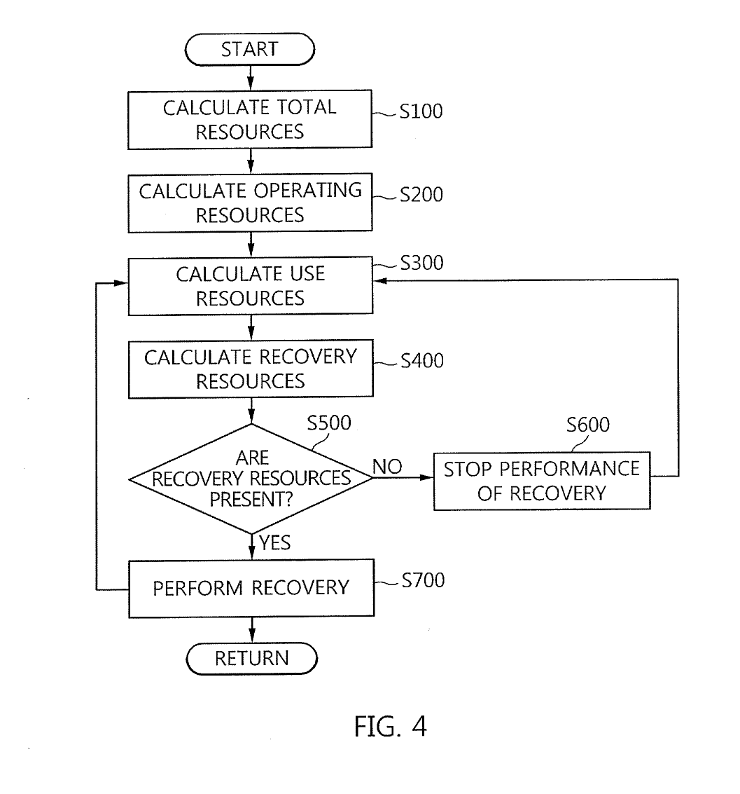

A method of recovering the failed disk of a virtual machine according to an embodiment of the present invention is described below. FIG. 4 is a flowchart illustrating the method of recovering the failed disk of a virtual machine according to this embodiment of the present invention.

Referring to FIG. 4, the method of recovering the failed disk of a virtual machine according to this embodiment of the present invention includes calculating the total resources, that is, network and disk I/O resources, of a virtualization system at step S100, calculating operating resources, that is, resources used to drive the virtualization system at step S200, calculating use resources, that is, the amount of the network and disk I/O resources used, at step S300, calculating recovery resources, that is, network and disk I/O bandwidths capable of being assigned to failure recovery without disturbing the performance of other virtual machines based on the total resources, the operating resources and the use resources, at step S400, determining whether or not the recovery resources are present at step S500, stopping the performance of the recovery if, as a result of the determination, it is determined that the recovery resources have not been assigned at step S600, and performing recovery if, as a result of the determination, it is determined that the recovery resources have been assigned at step S700. Steps S600 and S700 may return to step S300. Accordingly, use resources may be calculated in real time, and then recovery may be performed or stopped. Each of these steps is described in detail below.

At step S100 of calculating the total resources, that is, network and disk I/O resources, of a virtualization system, the total resources mean all system resources corresponding to a ratio of 1 in FIG. 3 and refer to network I/O and disk I/O.

After the total resources have been calculated, operating resources, that is, resources used to drive the virtualization system, are calculated at step S200. In this case, the operating resources are required to drive the virtualization system in a virtualization server, and correspond to 1−X in FIG. 3.

After the operating resources have been calculated, use resources, that is, the amount of the network and disk I/O resources used, are calculated at step S300. In this case, the use resources mean resources that belong to the total resources and correspond to Y other than the resources corresponding to the 1−X, and are used to drive a virtual machine. A change in the use resources is detected in real time.

After the use resources has been calculated, recovery resources, that is, network and disk I/O bandwidths capable of being assigned to failure recovery without disturbing the performance of other virtual machines based on the total resources, the operating resources and the use resources, are calculated at step S400. In this case, the recovery resources mean the remaining resources of the total resources other than the operating resources and the use resources, and refer to resources used to recover the failed disk of a virtual machine. That is, the recovery resources correspond to X−Y in FIG. 3. The recovery resources correspond to a parameter that may vary in real time depending on a change in the use resources. More specifically, the recovery resources are used to recover the failed disk of a virtual machine.

After the recovery resources have been calculated, whether or not the recovery resources are present is determined at step S500. If, as a result of the determination, it is determined that the recovery resources have not been ensured (i.e., X−Y=0), an operation of recovering the failed disk of a virtual machine is stopped at step S600. If, as a result of the determination, it is determined that the recovery resources have been ensured, recovery is performed at step S700. Steps S600 and S700 may return to step S300. Accordingly, whether or not to perform recovery is determined based on a real-time change in the use resources.

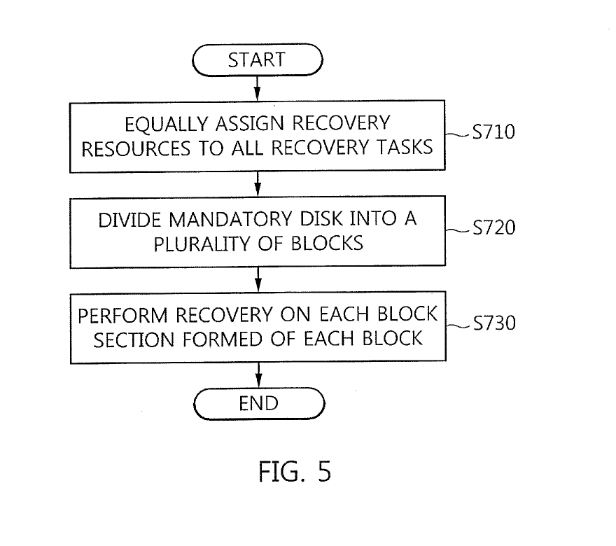

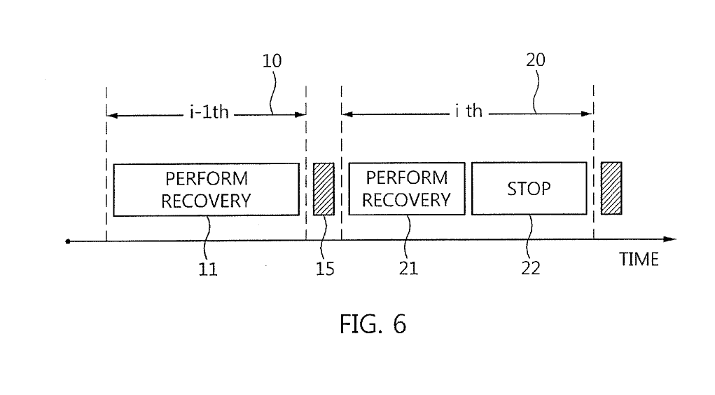

The execution of the method of recovering the failed disk of a virtual machine and a method of controlling resource use bands are described below. FIGS. 5 and 6 are diagrams illustrating the execution of the method of recovering the failed disk of a virtual machine and the method of controlling resource use bands.

The performance of recovery described with reference to FIGS. 5 and 6 is based on the assumption that recovery resources have been ensured as described above. A detailed process of the performance of recovery is described below with reference to FIG. 5. Step S700 of performing recovery includes providing all recovery tasks with assignment resources to which the recovery resources have been equally assigned if the recovery resources have been assigned at step S710, dividing the mandatory disk into a plurality of blocks at step S720, and performing recovery on each block section formed of each of the blocks based on the assignment resources at step S730.

More specifically, at step S710 of providing all recovery tasks with assignment resources to which the recovery resources have been equally assigned, the network and disk I/O bandwidths, that is, the recovery resources calculated at step S400, are equally assigned to all the recovery tasks. In this case, use resources calculated at step S300 are periodically updated, and then steps S300 to S700 are repeatedly performed. Thereafter, the mandatory disk is divided into the plurality of blocks at step S720, and recovery is performed on each block section formed of each of the blocks of a specific size at step S730.

FIG. 6 illustrates a method of controlling resource use bands in the task of recovering a failed disk. In order to satisfy the bandwidths of an (i−1)-th block section and an i-th block section, assignment resources 10 and 20 are configured to include idle resources. That is, the i-th block section is divided into a region 21 in which recovery is performed and idle resources 22, that is, a region in which recovery is stopped. That is, assigned network and disk I/O bandwidths may be satisfied by stopping the task during the region corresponding to the idle resources 22. In this case, the idle resources 22 assigned to the i-th block section 20 are calculated based on network and disk I/O performance in the block section 10 (15).

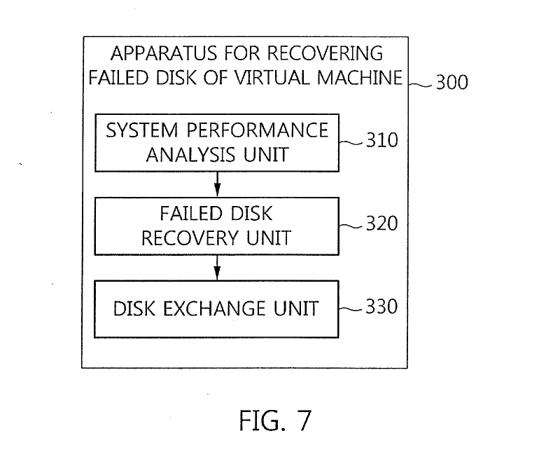

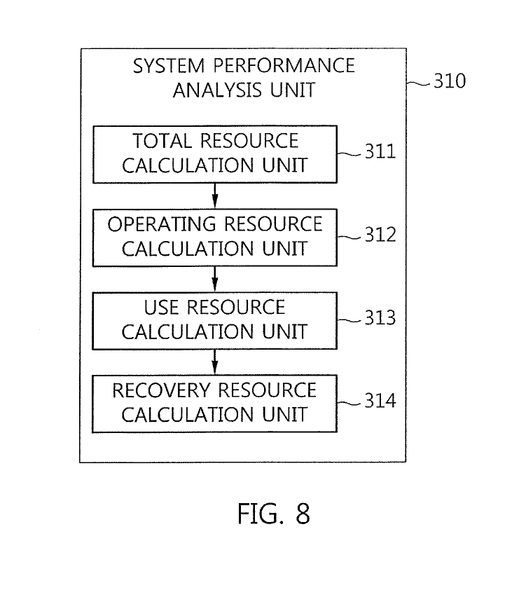

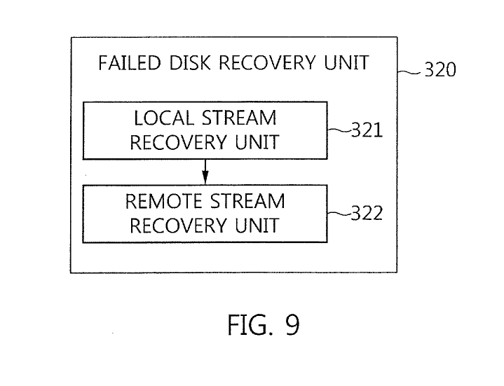

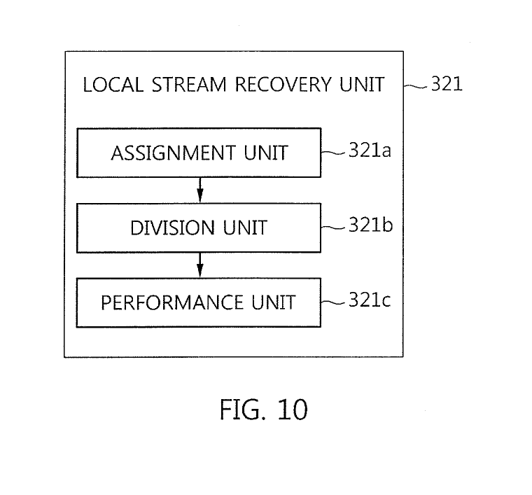

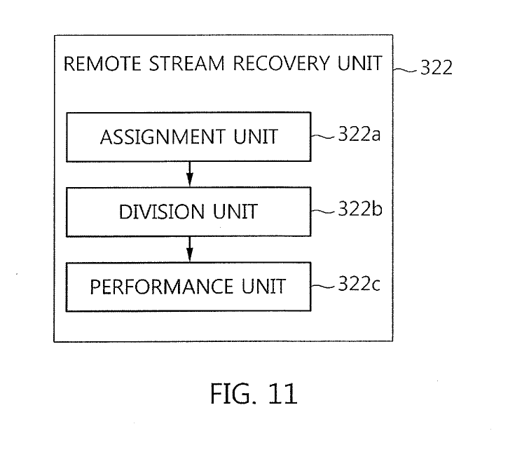

An apparatus for recovering the failed disk of a virtual machine according to an embodiment of the present invention is described below. FIG. 7 is a block diagram of the apparatus for recovering the failed disk of a virtual machine according to an embodiment of the present invention, FIG. 8 is a diagram illustrating the configuration of the system performance analysis unit of the apparatus for recovering the failed disk of a virtual machine according to an embodiment of the present invention, FIG. 9 is a diagram illustrating the configuration of the failed disk recovery unit of the apparatus for recovering the failed disk of a virtual machine according to an embodiment of the present invention, and FIGS. 10 and 11 are diagrams illustrating the configuration of the local and remote stream recovery units of the apparatus for recovering the failed disk of a virtual machine according to an embodiment of the present invention.

Referring to FIG. 7, the virtual machine failed disk apparatus 300 according to this embodiment of the present invention includes a system performance analysis unit 310, a failed disk recovery unit 320, and a disk exchange unit 330.

The system performance analysis unit 310 functions to analyze the performance of a virtualization system and calculate recovery resources, that is, network and disk I/O bandwidths that may be assigned to failure recovery. More specifically, the system performance analysis unit 310 includes a total resource calculation unit 311 configured to calculate total resources, that is, the total network and disk I/O resources of a virtualization system, an operating resource calculation unit 312 configured to calculate operating resources, that is, resources used to drive the virtualization system, a use resource calculation unit 313 configured to calculate use resources, that is, the amount of the network and disk I/O resources used, and a recovery resource calculation unit 314 configured to calculate recovery resources, that is, network and disk I/O bandwidths capable of being assigned to failure discovery without disturbing the performance of other virtual machines based on the total resources, the operating resources and the use resources. The total resources mean all system resources corresponding to the ratio 1 in FIG. 3, and refer to network and disk I/O resources. The operating resources are required to drive the virtualization system in a virtualization server, and correspond to 1−X in FIG. 3. The use resources mean resources that belong to the total resources and correspond to Y other than the resources corresponding to the 1−X, and are used to drive a virtual machine. The recovery resources mean the remaining resources of the total resources other than the operating resources and the use resources, and refer to resources used to recover the failed disk of a virtual machine. That is, the recovery resources correspond to X−Y in FIG. 3. The recovery resources correspond to a parameter that may vary in real time depending on a change in the use resources. More specifically, the recovery resources are used to recover the failed disk of a virtual machine.

If the recovery resources have not been ensured (i.e., X−Y=0) after the recovery resources have been calculated, the failed disk recovery unit 320 does not operate. If the recovery resources have been ensured, however, the failed disk recovery unit 320 executes recovery. The system performance analysis unit 310 repeatedly operates in real time, and thus, whether or not to perform recovery is determined depending on whether or not recovery resources have been ensured in real time.

The failed disk recovery unit 320 includes a local stream recovery unit 321 configured to recover a copy disk, that is, a copy of a local mandatory disk stored in a local storage device, by copying the copy disk in a local stream manner using the local mandatory disk, and a remote stream recovery unit 322 configured to recover a copy disk, that is, a copy of a remote mandatory disk stored in a remote storage device, by copying the copy disk in a remote stream manner using the remote mandatory disk. For example, referring to FIGS. 1 and 2, if the use disk 411 of the virtual machine 1 100 has failed and thus becomes the failed disk 411, the copy disk 412 is recovered using the mandatory disk 1 413 stored in the local storage device 400 or the mandatory disk 2 510 stored in the remote storage device 500 in order to recover the failed disk 411. More specifically, when the copy disk 412 is recovered, a method of recovering the copy disk 412 in a stream manner is adopted. The mandatory disk 1 413 is used in a local stream manner, and the mandatory disk 2 510 is used over a network in a remote stream manner.

The local stream recovery unit 321 includes an assignment unit 321 a configured to provide all recovery tasks with assignment resources to which the recovery resources have been equally assigned, a division unit 321b configured to divide the mandatory disk into a plurality of blocks, and a performance unit 321c configured to perform recovery on each block section formed of each of the blocks based on the assignment resources. Furthermore, the remote stream recovery unit 322 includes an assignment unit 322a configured to provide all recovery tasks with assignment resources to which the recovery resources have been equally assigned, a division unit 322b configured to divide the mandatory disk into a plurality of blocks, and a performance unit 322c configured to perform recovery on each block section formed of each of the blocks based on the assignment resources.

For example, referring back to FIGS. 1 and 2, the disk exchange unit 330 deletes the failed disk 411, and assigns the recovered copy disk 412 to the virtual machine 1 100, thereby completing the recovery of the failed disk 411. In this case, the failed disk 411 and the copy disk 412 may be replaced with each other because they are present in the same local storage device 400.

The method of controlling resource use bandwidths in the task of executing a failed disk is illustrated in FIG. 6. In order to satisfy the bandwidths of the (i−1)-th block section and the i-th block section, the assignment resources 10 and 20 are configured to include idle resources. That is, the i-th block section is divided into the region 21 in which recovery is performed, and the idle resources 22, that is, a region in which recovery is stopped. That is, assigned network and disk I/O bandwidths may be satisfied by stopping the task during the region corresponding to the idle resources 22. In this case, the idle resources 22 assigned to the i-th block section 20 are calculated based on network and disk I/O resource performed in the block section 10 (15).

As described above, at least one embodiment of the present invention has the advantage of recovering the failed disk of a virtual machine while maintaining the continuity of virtualization service in a server virtualization environment.

At least one embodiment of the present invention has the advantage of recovering the failed disk of a virtual machine while ensuring the performance of virtual machines.

At least one embodiment of the present invention has the advantage of preventing the performance of virtual machines from being deteriorated during the performance of recovery by scheduling resources used to recover the failed disk of a virtual machine.

At least one embodiment of the present invention has the advantage of recovering the failed disk of a virtual machine based on a remote storage device when recovering the failed disk.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of recovering a failed disk of a virtual machine in a virtualization system, the method comprising:
calculating total resources of the virtualization system, that is, network and disk I/O resources;
calculating operating resources used to drive the virtualization system;
calculating use resources corresponding to an amount of the network and disk I/O resources used;
calculating recovery resources, that is, network and disk I/O bandwidths capable of being assigned to failure recovery without disturbing performance of other virtual machines based on the total resources, the operating resources and the use resources; and
performing recovery of a failed disk by recovering a copy disk, that is, a copy of the failed disk, in a stream manner using a mandatory disk stored in the virtualization system based on the recovery resources.

2. The method of claim 1, wherein performing the recovery of the failed disk comprises deleting the failed disk and assigning the recovered copy disk to a virtual machine corresponding to the failed disk.

3. The method of claim 1, wherein performing the recovery of the failed disk comprises recovering the failed disk by copying a copy disk, which is a copy of a local mandatory disk stored in a local storage device, in a local stream manner using the local mandatory disk.

4. The method of claim 1, wherein performing the recovery of the failed disk comprises recovering the failed disk by copying a copy disk, which is a copy of a remote mandatory disk stored in a remote storage device, in a remote stream manner using the remote mandatory disk.

5. The method of claim 1, wherein the recovery resources are remaining resources of the total resources other than the operating resources and the use resources.

6. The method of claim 1, wherein performing the recovery of the failed disk is stopped if the recovery resources have not been assigned.

7. The method of claim 1, wherein performing the recovery of the failed disk comprises:
providing all recovery tasks with assignment resources to which the recovery resources have been equally assigned if the recovery resources have been assigned;
dividing the mandatory disk into a plurality of blocks; and
performing recovery on each block section formed of each of the blocks based on the assignment resources.

8. The method of claim 5, wherein the assignment resources comprise idle resources in which the performance of the recovery is stopped.

9. The method of claim 6, wherein the idle resources are assigned based on network or disk I/O resource performed in a block section before the former block section.

10. The method of claim 1, wherein performing the recovery of the failed disk comprises performing the recovery of the failed disk while periodically calculating the use resources and the recovery resources.

11. An apparatus for recovering a failed disk of a virtual machine in a virtualization system, the apparatus comprising:
a system performance analysis unit configured to calculate recovery resources, that is, network and disk I/O bandwidths, to be assigned to recovery of a failed disk by analyzing performance of the virtualization system;
a failed disk recovery unit configured to perform the discovery of the failed disk by recovering a copy disk, that is, a copy of the failed disk, using a mandatory disk stored in the virtualization system while ensuring performance of virtual machines based on the recovery resources; and
a disk exchange unit configured to delete the failed disk and assign the recovered copy disk to a virtual machine corresponding to the failed disk.

12. The apparatus of claim 11, wherein the system performance analysis unit comprises:
a total resource calculation unit configured to calculate total resources, that is, total network and disk I/O resources of the virtualization system;
an operating resource calculation unit configured to calculate operating resources used to drive the virtualization system;
a use resource calculation unit configured to calculate use resources, that is, an amount of the network and disk I/O resources used; and
a recovery resource calculation unit configured to calculate recovery resources, that is, network and disk I/O bandwidths capable of being assigned to failure discovery without disturbing the performance of other virtual machines based on the total resources, the operating resources and the use resources.

13. The apparatus of claim 11, wherein the failed disk recovery unit comprises:
a local stream recovery unit configured to recover a copy disk, which is a copy of a local mandatory disk stored in a local storage device, by copying the copy disk in a local stream manner using the local mandatory disk; and
a remote stream recovery unit for recovering a copy disk, which is a copy of a remote mandatory disk stored in a remote storage device, by copying the copy disk in a remote stream manner using the remote mandatory disk.

14. The apparatus of claim 12, wherein the recovery resources are remaining resources of the total resources other than the operating resources and the use resources.

15. The apparatus of claim 11, wherein the failed disk recovery unit is stopped if the recovery resources have not been assigned.

16. The apparatus of claim 13, wherein the failed disk recovery unit is performed again if the recovery resources have been assigned.

17. The apparatus of claim 13, wherein the local stream recovery unit and the remote stream recovery unit comprises:
an assignment unit configured to provide all recovery tasks with assignment resources to which the recovery resources have been equally assigned;
a division unit configured to divide the mandatory disk into a plurality of blocks; and
a performance unit configured to perform recovery on each block section formed of each of the blocks based on the assignment resources.

18. The apparatus of claim 17, wherein the assignment resources comprise idle resources in which the performance of the recovery is stopped.

19. The apparatus of claim 18, wherein the idle resources are assigned based on network or disk I/O resource performed in a block section before the former block section.

20. The apparatus of claim 11, wherein the system performance analysis unit periodically calculates the recovery resources.
